(19) United States
(12) Patent Application Publication
(10) Pub. No.: US 2005/0086143 A1
(43) Pub. Date: Apr. 21, 2005

(54) Methods of pari-mutuel wagering based upon fixed odds and/or share purchase

(76) Inventors: Kenneth A. Vlazny, York, PA (US); John D. Revelle, Julian, CA (US)

Correspondence Address: TRASK BRITT, P.O. BOX 2550, SALT LAKE CITY, UT, 84110, US

(21) Appl. No.: 10/690,474

(22) Filed: Oct. 21, 2003

(51) Int. Cl. G06F 17/60

(52) U.S. Cl. 705/35

(57) ABSTRACT

A method of wagering in which pari-mutuel wagers are placed at odds specified by the game participant and pari-mutuel payouts are calculated based upon the specified odds is provided. Odds on the original wagers of all winning game participants are paid beginning with those that accepted the lowest odds for their wager and progressing sequentially toward those that accepted the highest odds for their wager. Odds are paid out in this manner until the available wagering pool is exhausted, at which time any surplus remaining in the available wagering pool may be distributed. Also provided is a method of wagering wherein pari-mutuel payouts are calculated based upon a number of outstanding shares purchased at current but fluctuating share prices in anticipation of a particular outcome of a given event.

### BACKGROUND OF THE INVENTION

1. Field of the Invention

The present invention relates generally to methods of wagering. More particularly, the present invention relates to a method of wagering in which pari-mutuel wagers are placed at odds specified by the game participant and pari-mutuel payouts are calculated based upon the specified odds. Still further, the present invention relates to a method of wagering wherein pari-mutuel payouts are calculated based upon a number of outstanding shares purchased at current but fluctuating share prices in anticipation of a particular outcome of a given event.

2. State of the Art

Fixed odds individual wagering is one of the oldest forms of wagering. In fixed odds individual wagering, game participants agree on a proposition (i.e., the odds at which they will either place or accept a wager), one against another. Once accepted, a given proposition is fixed until the outcome of the wagered-on event is determined, at which time the appropriate payout is made. In a more contemporary form, fixed odds individual wagering may be facilitated by one of a number of websites which permit game participants to place and accept propositions on-line. The website administrator simply retains a small commission for providing the service of connecting the wagering parties.

A second type of fixed odds wagering involves the use of an intermediary, generally referred to as a bookie. A bookie typically sets propositions for a given event based upon his or her assessment of the likely outcome of the event. Persons wishing to wager on the event place wagers against those propositions which, once accepted, remain fixed until the outcome of the event is determined and the appropriate payout is made. The bookie may adjust his line (i.e., his propositions) to control his exposure and maximize wagering. However, any wager placed against a given proposition, and accepted prior to the line adjustment, will not change.

Sports betting and lottery draws are examples of fixed odds wagering games. In lottery draw games, the sponsoring association makes a representation of odds at which lottery tickets will pay and game participants purchase tickets against those odds.

Fixed odds wagering, whether among individuals directly or through an intermediary, offers game participants the advantage of knowing, at the time they place their wager, what payout they will receive if they placed their wager on a winning outcome of the event. The potential payout is not subject to change between the time that the wager is placed, or the proposition is accepted, and the outcome of the event is determined. This affords game participants a level of predictability that many desire. However, as with fixed odds wagering there is a risk of having too many winning wagers placed on a given event which would require the intermediary to pay out an amount in excess of that which was taken in, the individual or intermediary who sets the propositions always has a stake in the outcome of the event. Thus, game participants are limited on the wagers they may place on an event by the propositions which another wagering party is willing to set.

Pari-mutuel wagering is another form of wagering in which all game participants who place a wager on a winning outcome of a particular event share in the pool of money wagered in proportion to the amount of their wager. The gaming establishment, or intermediary, hosting or sponsoring the event has no stake in the outcome of the event and, thus, game participants are not playing against the gaming establishment but only against other game participants. This may result in more favorable odds being offered to the game participants than if the gaming establishment or intermediary has a stake in the outcome. The gaming establishment simply deducts a fixed percentage from each dollar wagered for administrative purposes and the like, e.g., for funding of purses and payment of taxes and other expenses. The remainder of the pari-mutuel wagering pool is shared proportionately among those game participants who wagered on the winning outcome.

Final prices (i.e., the end value that a game participant receives for a their wager, typically stated as per the minimum acceptable wager amount) for pari-mutuel wagering pools are typically calculated by totaling the wagering pool, subtracting the percentage retained by the gaming establishment, and apportioning the remaining amount to all game participants who wagered on the winning outcome of the event (i.e., winning game participants) in proportion to the amount of their individual wagers. Each game participant places his or her wager based upon the odds and probable prices as determined at the time the wager is placed. However, the odds change as money wagered on the event is added to the wagering pool and wagers are placed on the various potential outcomes. All winning game participants, however, receive the same final odds, regardless of the status of the odds when their wager is placed. Thus, there is a fair amount of uncertainty for the game participants when they place their wagers concerning the final prices. Consequently, there is an incentive for game participants to wait until near the end of the period in which wagers on the event are being accepted as the odds are less likely to significantly change the closer the wager is placed to the post time. This dynamic may result in a reduction in wagering revenue in the early stages of the period in which wagers are accepted for a pari-mutuel event, and a reduction near post time as potential game participants wagering at the lat minute are precluded from placing wagers because the pool is locked.

In light of the above, a method of wagering which combines the benefits of conventional pari-mutuel wagering with those of fixed odds wagering would be advantageous. More particularly, a method of wagering which may offer game participants more favorable odds than if the gaming establishment or intermediary has a stake in the outcome of the event, and which has a higher degree of payout predictability than conventional pari-mutuel wagering would be desirable and would likely result in more wagers being placed earlier in the wagering period.

### BRIEF SUMMARY OF THE INVENTION

The present invention, in one embodiment, includes a method of wagering in which pari-mutuel wagers are placed at odds specified by the game participant and pari-mutuel payouts are calculated based upon the specified odds. Game participants place one or more wagers on a particular event and, at the time each wager is placed, specify the odds that they will accept for the wager. The event is commenced and the outcome thereof is determined. Subsequently, those game participants that placed a wager on a winning outcome of the event may receive, at a minimum, a return of their original wager. Winning game participants may also receive odds on their original wager, at the odds level at which the original wager was placed. The payout begins with the winning game participants who accepted the lowest odds for their wager (e.g., 1 to 1 odds) and progresses sequentially toward those game participants who accepted the highest odds for their wager (e.g., 100 to 1 odds). All winning game participants are paid out in this manner until the available pari-mutuel wagering pool is exhausted.

As odds on the original wagers are paid out according to the odds at which the original wagers are placed, rather than the actual odds that would be indicated based upon the composition of the available pari-mutuel wagering pool, two situations may occur which do not generally arise in conventional pari-mutuel wagering. First, the funds in the available pari-mutuel wagering pool may be insufficient to cover all wagers placed if one or more particular outcomes prove to be a winning outcome for the event. Second, there may be a surplus of funds in the available pari-mutuel wagering pool once all winning game participants that are to be paid out according to the rules of the game have been adequately compensated. The present invention includes ways in which each of these situations may be handled.

In another embodiment, the present invention includes a method of wagering wherein game participants purchase shares in favor of a particular outcome of a given event at current but fluctuating share prices and, if the particular outcome is a winning outcome, may receive a return of the original amount wagered plus a dividend for each share they hold. The amount of the dividend may be calculated by dividing the funds in the share wagering pool, less the takeout, by the number of outstanding shares purchased in favor of the winning outcome of the event.

The present invention introduces to pari-mutuel wagering the ability for game participants to win different amounts for a given event outcome and introduces to fixed odds wagering the ability for game participants to have more control when placing their wagers; both of which are novel features which make wagering more competitive and interesting.

Other features and advantages of the present invention will become apparent to those of ordinary skill in the art through consideration of the ensuing description, the accompanying drawings and the appended claims.

### BRIEF DESCRIPTION OF THE SEVERAL VIEWS OF THE DRAWINGS

While the specification concludes with claims particularly pointing out and distinctly claiming that which is regarded as the present invention, the advantages of this invention may be more readily ascertained from the following description when read in conjunction with the accompanying drawings in which:

FIG. 1 is a flow diagram schematically illustrating a method of playing a fixed odds pari-mutuel wagering game in accordance with the present invention;

FIG. 2 illustrates an exemplary profile of a total amount of money wagered on each potential outcome of a hypothetical horse race, as well as odds for each horse based upon the exemplary profile;

FIG. 3A illustrates an exemplary wagering pool distribution, in terms of percentage of the total pari-mutuel wagering pool, for the hypothetical horse race of FIG. 2;

FIG. 3B illustrates weighted odds, calculated based upon the exemplary pool distribution of FIG. 3A, in comparison to the actual (conventional) odds calculated based upon the hypothetical profile of FIG. 2;

FIG. 4 illustrates an exemplary wagering pool distribution, in terms of monetary amounts, calculated based upon the total amount wagered, as shown in FIG. 2, and the exemplary wagering pool percentage distribution of FIG. 3A;

FIG. 5 illustrates the cumulative payouts, excluding original wager amounts, that would be necessary to pay odds to all winning game participants if each horse were to win the hypothetical horse race of FIG. 2;

FIG. 6 illustrates at which odds the available pari-mutuel wagering pool would be sufficient to pay out all winning game participants in the hypothetical horse race of FIG. 2 and at which odds the available pari-mutuel wagering pool would be insufficient for complete payout;

FIG. 7 illustrates, based upon the hypothetical horse race of FIG. 2, the amount of money necessary to pay back the original wager amounts to all winning game participants and to pay odds to all winning game participants who wagered at the max odds payout or below, the amount of surplus in the available pari-mutuel wagering pool subsequent to such payout, and the surplus share per $1.00 wagered if only those winning game participants who placed wagers at the max odds payout or below share in the surplus;

FIG. 8 illustrates the amount per $1.00 wagered that each winning game participant would receive in the payout scenario of FIG. 7;

FIG. 9 illustrates, based upon the hypothetical horse race of FIG. 2, the amount of money necessary to pay back the original wager amounts to all winning game participants and to pay odds to all winning game participants who wagered at the max odds payout or below, the amount of surplus in the available pari-mutuel wagering pool subsequent to such payout, and the surplus share per $1.00 wagered if only those winning game participants who placed wagers at the max odds payout share in the surplus;

FIG. 10 illustrates the amount per $1.00 wagered that each winning game participant would receive in the payout scenario of FIG. 9;

FIG. 11 illustrates, based upon the hypothetical horse race of FIG. 2, the amount of money necessary to pay back the original wager amounts to all winning game participants and to pay odds to all winning game participants who wagered at the max odds payout or below, the amount of surplus in the available pari-mutuel wagering pool subsequent to such payout, and the surplus share per $1.00 wagered if all winning game participants share in the surplus;

FIG. 12 illustrates the amount per $1.00 wagered that each winning game participant would receive in the payout scenario of FIG. 11; and

FIG. 13 is a flow diagram schematically illustrating a method of playing a pari-mutuel share wagering game in accordance with the present invention.

### DETAILED DESCRIPTION OF THE INVENTION

The present invention is directed to a method of wagering in which pari-mutuel wagers are placed on a particular outcome of a given event and pari-mutuel payouts are calculated based upon odds specified by the game participant at the time the wager is placed. The present invention further relates to a method of wagering wherein pari-mutuel payouts are calculated based upon a number of outstanding shares purchased at current but fluctuating share prices in anticipation of a particular outcome of a given event. The particular embodiments described herein are intended in all respects to be illustrative rather than restrictive. Other and further embodiments will become apparent to those of ordinary skill in the art to which the present invention pertains without departing from its scope.

As previously stated, conventional pari-mutuel wagering offers a number of benefits to game participants including, but not limited to, the possibility of more favorable odds as the gaming establishment hosting or sponsoring the event has no stake in the outcome thereof. Fixed odds wagering also offers game participants advantages, namely, predictability in the amount of a potential payout if he/she places a wager on a winning outcome of the event. In one embodiment, the present invention combines advantages of conventional pari-mutuel wagering with those of fixed odds wagering and offers game participants a method of wagering that may offer more favorable odds than fixed odds wagering and a higher degree of payout predictability than conventional pari-mutuel wagering.

In this embodiment, game participants place one or more wagers on a particular event and, at the time each wager is placed, specify the odds (or price) that they will accept for the wager. The event is commenced and the outcome thereof is determined. Subsequently, those game participants that placed a wager on a winning outcome of the event (i.e., winning game participants) may receive, at a minimum, a return of their original wager. Winning game participants also may receive odds on their original wager, at the odds level at which the original wager was placed. The payout begins with the winning game participants who accepted the lowest odds for their wager (e.g., 1 to 1 odds) and progresses sequentially toward those game participants who accepted the highest odds for their wager (e.g., 100 to 1 odds). All winning game participants are paid in this manner until the available pari-mutuel wagering pool is exhausted.

There are three possibilities for each wager placed on a particular event. First, the outcome on which the wager is placed may not be a winning outcome. In this instance, the game participant simply loses his original wager. Second, the outcome on which the wager is placed may be a winning outcome and there may be sufficient funds in the available pari-mutuel wagering pool to payout the game participant who placed the wager, according to the odds at which the wager was placed. Neither of these first two possibilities requires any further explanation.

However, as odds on the original wagers are paid out sequentially according to the odds at which the original wagers are placed, rather than the actual (conventional) odds that would be indicated based upon the composition of the available pari-mutuel wagering pool, a third possibility exists which presents an issue not encountered in conventional fixed odds wagering or conventional pari-mutuel wagering. According to this third possibility, the outcome on which a wager is placed may be a winning outcome but the funds in the available pari-mutuel wagering pool may be insufficient to payout the game participant who placed the wager, at the odds at which the wager was placed. If the available pari-mutuel wagering pool contains insufficient funds to payout all winning game participants, at the odds at which the wagers are originally placed, a number of different alternatives may be implemented. Some exemplary “out of money” alternatives are discussed more fully below.

It is noted that a second issue which is not encountered in conventional fixed odds wagering or conventional pari-mutuel wagering may arise in the fixed odds pari-mutuel wagering method of the present invention. As odds on the original wagers are paid out sequentially according to the odds at which the original wagers are placed, rather than the actual (conventional) odds that would be indicated based upon the composition of the available pari-mutuel wagering pool, there may be a surplus of funds in the available pari-mutuel wagering pool once all winning game participants that are to be paid out according to the rules of the wagering game have been adequately compensated. This issue may arise in both the scenario in which the available pari-mutuel wagering pool is sufficient to payout all winning game participants, at the odds at which the original wagers are placed, and in the scenario in which the available pari-mutuel wagering pool is insufficient to payout all winning game participants. The present invention provides methods in which a wagering pool surplus may be handled, as more fully described below.

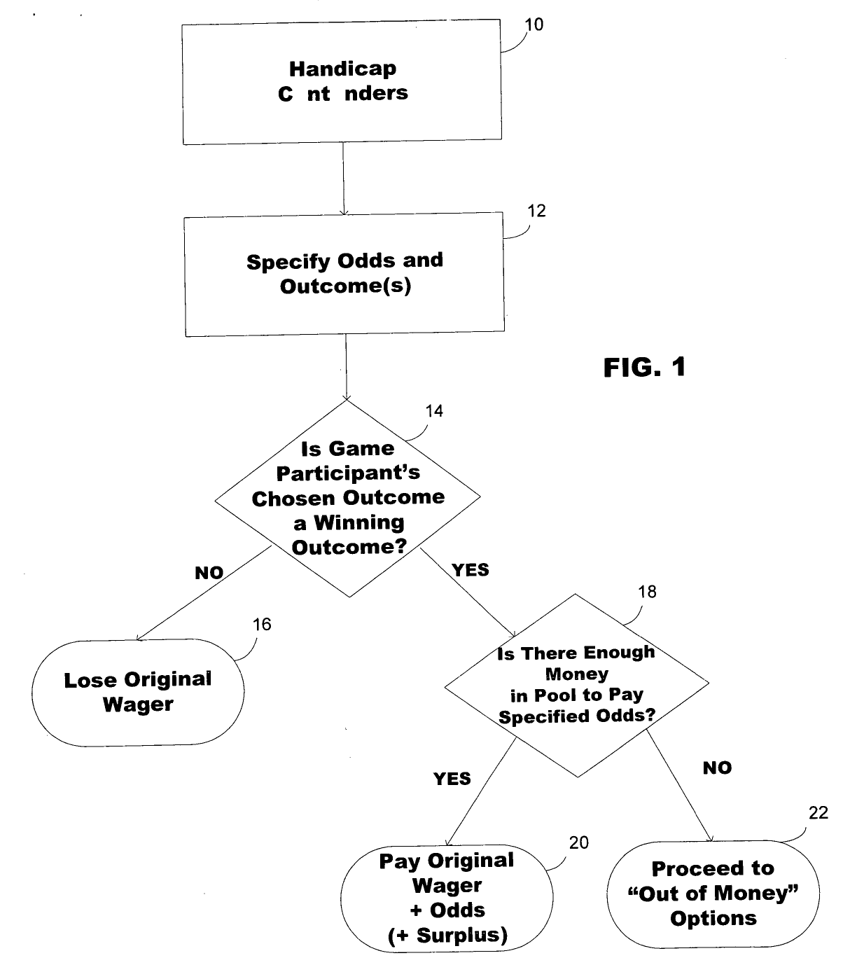

Referring now to FIGS. 1 through 12, an exemplary scenario illustrating a fixed odds pari-mutuel wagering method according to the present invention is shown in more detail and in the context of a horse race having eight contenders. It will be understood and appreciated by those of ordinary skill in the art, however, that the present invention is not so limited to this context but may be used in any wagering scheme wherein conventional pari-mutuel wagering may be implemented including, but not limited to, wagers placed on sporting events and the like. The present invention is intended to encompass any and all such contextual variations.

With initial reference to FIG. 1, a flow diagram showing a method of playing a fixed odds pari-mutuel wagering game in accordance with the present invention is schematically illustrated. As shown at reference numeral 10, each game participant desiring to place one or more wagers on a particular outcome of the horse race may initially handicap the contenders in the event. For instance, a game participant may examine historical information regarding each horse running the race and form a judgment regarding what he believes the outcome of the race will be. Once a game participant is satisfied with his judgment of the contenders and has decided what he believes a winning outcome of the race will be, he may place a wager on that outcome and specify the odds at which he will accept the wager. This is shown at reference numeral 12.

By way of example, and not limitation, game participant A may place a wager of $1.00 at 8 to 1 odds on horse number 6 winning the race while game participant B may place a wager of $1.00 at 6 to 1 odds on horse number 2 winning the race. It will be understood by those of ordinary skill in the art that monetary amounts other than $1.00 may be wagered by a game participant. In the present example, wagers of $1.00 are illustrated merely for the sake of simplicity. It will be further understood that a game participant may place more than one wager on the event, either on the same outcome but at different odds, or on different outcomes of the event. Potential wagers are limited only by the rules and regulations set forth for the event.

It is currently preferred that game participants place their wagers and specify their odds without knowledge of the wagers other game participants may place. For instance, by way of example and not limitation, the pari-mutuel wagering pool and would-be odds may not be visible to the game participants. The lack of information in this example would add an element of anticipation and excitement about the odds to the game that is not present in conventional pari-mutuel wagering.

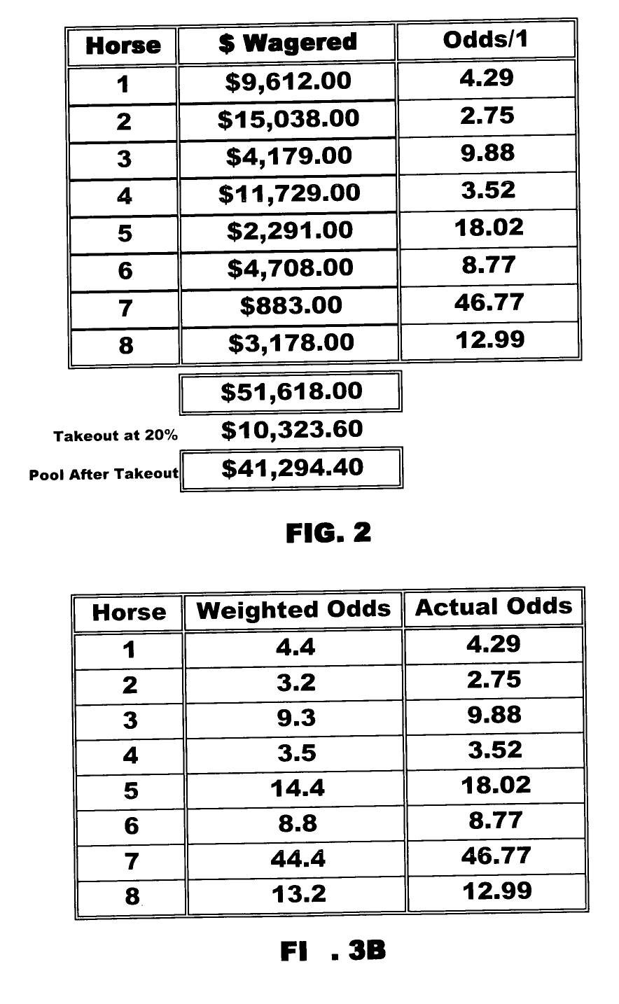

Referring to FIG. 2, a hypothetical profile of an amount which may be wagered on each horse in the exemplary horse race is shown. As can be seen, a total of $51,618.00 was wagered on the horse race in this example. While the race track has no stake in the outcome of the race, typically, as with conventional pari-mutuel wagering, it will retain a takeout or percentage of each dollar wagered for administrative purposes and for hosting and/or sponsoring the event. In this example, the takeout is 20% or $10,323.60. Accordingly, the total available pari-mutuel wagering pool, subsequent to takeout, is $41,294.40.

FIG. 2 also illustrates the actual (conventional) final odds for each horse calculated by dividing the total pari-mutuel wagering pool, prior to takeout, by the total amount wagered on each horse. In conventional pari-mutuel wagering, each game participant who placed a wager on a winning outcome of the horse race would receive a payout according to these odds. That is, if horse number 3 wins the race, each game participant who wagered on horse number 3 would receive $9.88 for each $1.00 wagered, regardless of the odds at which he or she placed their wager. However, in the method of the present invention, each game participant who placed a wager on a winning outcome of the race will instead receive a payout according to the odds at which their original wager was placed, provided the available pari-mutuel wagering pool is sufficient to payout all winning game participants, as more fully described below.

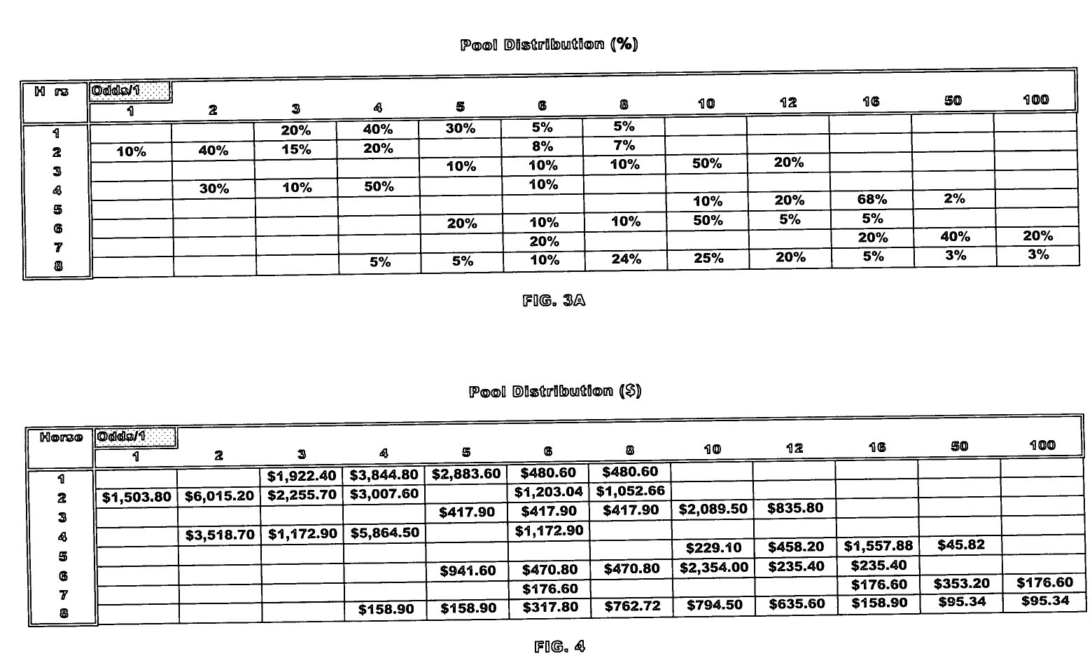

With reference to FIG. 3A, an exemplary wagering pool distribution, in terms of percentage of the total pari-mutuel wagering pool, is shown. For example, of the $9,612.00 wagered on horse number 1 in FIG. 2, 20% was wagered by game participants at 3 to 1 odds, 40% was wagered at 4 to 1 odds, 30% was wagered at 5 to 1 odds, and so on. From this exemplary distribution of wagered amounts, weighted odds (as shown in FIG. 3B) may be calculated. The weighted odds reflect the odds specified by game participants at the time their wagers were placed.

FIG. 3B illustrates a comparison of the weighted odds based upon this hypothetical wagering pool distribution and the actual (conventional) odds based upon the monetary amount wagered on each horse as a fraction of the total pari-mutuel wagering pool, as calculated in FIG. 2. FIGS. 3A and 3B are intended to illustrate that the hypothetical wagering pool distribution of FIG. 3A is estimated to closely approximate a distribution which would be possible based upon the actual odds shown in FIG. 2.

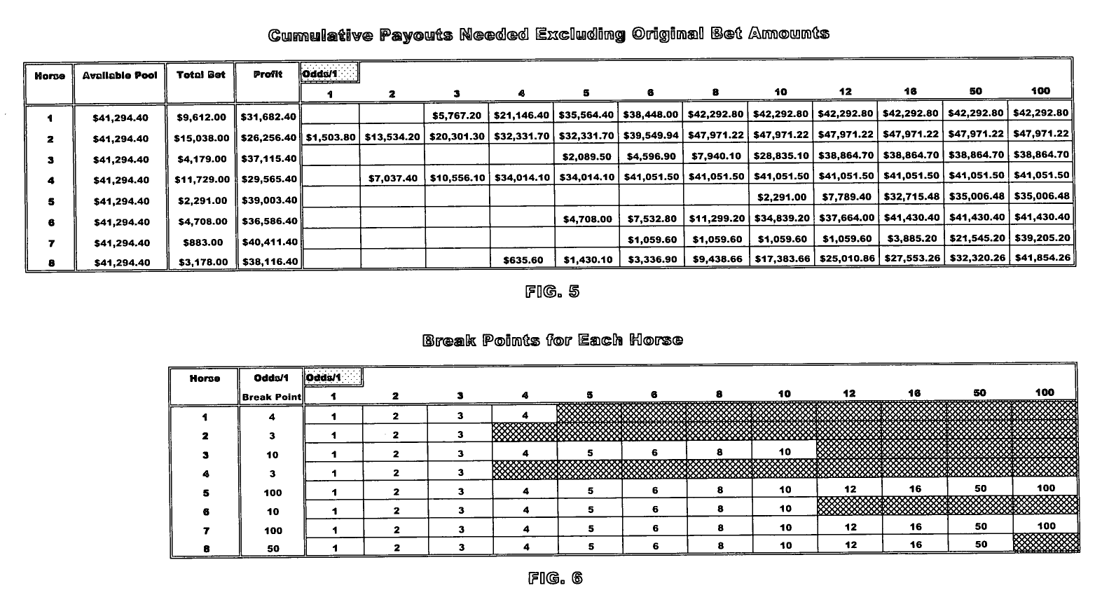

With reference to FIG. 4, a monetary distribution of wagers is shown, calculated by multiplying the total monetary amount wagered on each horse (FIG. 2) by the fraction of that amount that was wagered at the specified odds (FIG. 3A). For instance, $9,612.00 was wagered on horse number 1, of which 20% was wagered at 3 to 1 odds. Thus, $1,922.40 was wagered on horse number 1 at 3 to 1 odds. FIG. 4 thus illustrates the funds that would be necessary to return only the original amount wagered to all game participants who placed a wager on a particular outcome of the horse race, if that outcome proves to be a winning outcome for the event. Amounts are broken down in FIG. 4 by the odds at which the original wagers are placed. The total funds necessary to return the original wager amounts to all game participants who place a wager on a winning outcome of the horse race are shown under the heading “$ Wagered” in FIG. 2 and under the heading “Total Bet” in FIG. 5.

Once the period for accepting wagers has been closed, the event is commenced and the outcome thereof is determined. This is shown by reference numeral 14 in FIG. 1. If the outcome on which a game participant placed his original wager is not a winning outcome, the game participant loses his original wager, as shown at reference numeral 16. However, if the outcome on which a game participant placed his original wager is a winning outcome, the available wagering pool may be evaluated to determine whether or not the funds therein are sufficient to pay the game participant at his specified odds, as shown at reference numeral 18.

FIGS. 5 and 6 illustrate the circumstances under which the funds in the available pari-mutuel wagering pool are sufficient to pay all game participants who placed wagers on the winning outcome of the event, at the odds which were specified at the time the wagers were placed, and those circumstances under which the funds are insufficient to pay all winning game participants. In the present example, the only winning outcome for a given horse is a “win” whereby the horse on which a game participant placed his/her wager places first in the race. It will be understood by those of ordinary skill in the art, however, that many other outcomes of a horse race may be considered winning outcomes for a game participant, the possible winning outcomes limited only by the rules and regulations set forth for the event. For instance, and not by way of limitation, many game participants placing wagers on a horse race specify “place” wagers wherein the game participant enjoys a winning outcome if the horse on which the wager is placed finishes first or second, “show” wagers wherein the game participant enjoys a winning outcome if the horse on which the wager is placed finishes first, second, or third, or “across the board” wagers wherein a game participant wagers that a horse will win, place, and show. All such variations are contemplated to be within the scope hereof.

In the method of the present invention, it is currently preferred that the amount of each winning game participant's original wager be returned, whether or not the available pari-mutuel wagering pool is sufficient to pay odds on the original wagers. Thus, before it can be determined whether or not the funds in the available pari-mutuel wagering pool are sufficient to pay all winning game participants odds on their original wagers, the available pari-mutuel wagering pool may be decreased by the amount wagered on the winning outcome of the event (the “total bet”). In this manner, the profit available for distribution may be calculated. If desired, the pool of wagers may alternatively be examined after all wagers have been placed and it may be determined at that time which wagers would not be covered even if placed on a winning outcome of the event. These wagers may then be separated from the wagering pool and refunded to the game participant, or otherwise disposed of, so as to avoid putting a game participant's wager at risk when the composition of the wagering pool is such that his or her wager would not be covered.

FIG. 5 illustrates the total funds that would be necessary to pay all game participants the specified odds on their original wagers if those original wagers are placed on a winning outcome of the race. If the funds in the available pari-mutuel wagering pool are sufficient, all winning game participants receive odds on their original wagers. This is, of course, the currently preferred outcome. However, as odds on the original wagers are paid out according to the odds at which the original wagers are placed, rather than the actual odds that would be indicated based upon the composition of the available pari-mutuel wagering pool, the funds may be insufficient to pay odds to all winning game participants. In this circumstance, it is currently preferred that payout of the winning game participants begin with those that accepted the lowest odds for their wager (e.g., 1 to 1 odds) and progress sequentially toward those winning game participants that accepted the highest odds for their wager (e.g., 100 to 1 odds). Accordingly, the amounts shown in FIG. 5 are cumulative.

For instance, in the illustrated example, a total of $1,922.40 was wagered on horse number 1 at 3 to 1 odds and a total of $3,844.80 was wagered on horse number 1 at 4 to 1 odds (see FIG. 4). If horse number 1 wins, $5,767.20 will be necessary to pay odds to all game participants that wagered on horse number 1 at 3 to 1 odds ($1,922.40 multiplied by 3) and $15, 379.20 will be necessary to pay odds to all game participants that wagered on horse number 1 at 4 to 1 odds ($3,844.80 multiplied by 4). However, as the payout for game participants in the method of the present invention begins with those game participants who accepted the lowest odds for their original wager, those wagering on horse number 1 at 4 to 1 odds will not be paid until those wagering on horse number 1 at 3 to 1 odds are paid. Thus, to pay all game participants who wagered on horse number 1 at 4 to 1 odds, a total of $21,146.40 will be necessary ($5,767.20 plus $15,379.20). It is these cumulative amounts that are shown in FIG. 5.

All game participants who placed a wager on the winning outcome are paid in this cumulative manner until the available pari-mutuel wagering pool is exhausted. FIG. 6 illustrates the odds at which the available pari-mutuel wagering pool contains sufficient funds to payout all winning game participants, at the odds at which their original wagers were placed, and those odds at which the available pari-mutuel wagering pool contains insufficient funds to payout all winning game participants. The odds at which the available pari-mutuel wagering pool contains insufficient funds to payout all winning game participants are shown as shaded grid boxes.

For example, if hypothetical game participant A wagered $1.00 at 8 to 1 odds on horse number 6 winning the race, it can be seen that there are sufficient funds for game participant A to receive odds on his wager. More particularly, with reference to FIG. 5, if horse number 6 wins the race, a total of $11,299.20 would be necessary to pay odds to all winning game participants that wagered on horse number 6 at 8 to 1 odds. As the available pari-mutuel wagering pool, after returning the initial wager amounts to all game participants that wagered on horse number 6, contains $36,586.40, there are sufficient funds to payout game participant A. Accordingly, game participant A would receive a return of his original wager of $1.00, odds of 8 to 1 on his original wager, or $8.00, and may be paid a proportional share of any surplus in the available wagering pool, as more fully described below. This is indicated by reference numeral 20 of FIG. 1.

Examination of FIG. 5 also reveals that there are insufficient funds to pay odds to hypothetical game participant B who wagered $1.00 at 6 to 1 odds on horse number 2 winning the race. More particularly, a total of $39,549.94 would be necessary to pay odds to all game participants that wagered at 6 to 1 odds on horse number 2. However, the available pari-mutuel wagering pool, after returning the initial wager amounts to all winning game participants, contains only $26,256.40. Thus, the funds are insufficient to payout odds to game participant B. When, as in the case of game participant B, the available wagering pool contains insufficient funds to payout odds to one or more winning game participants, a number of “out of money” options are available. This is indicated by reference numeral 22 of FIG. 1.

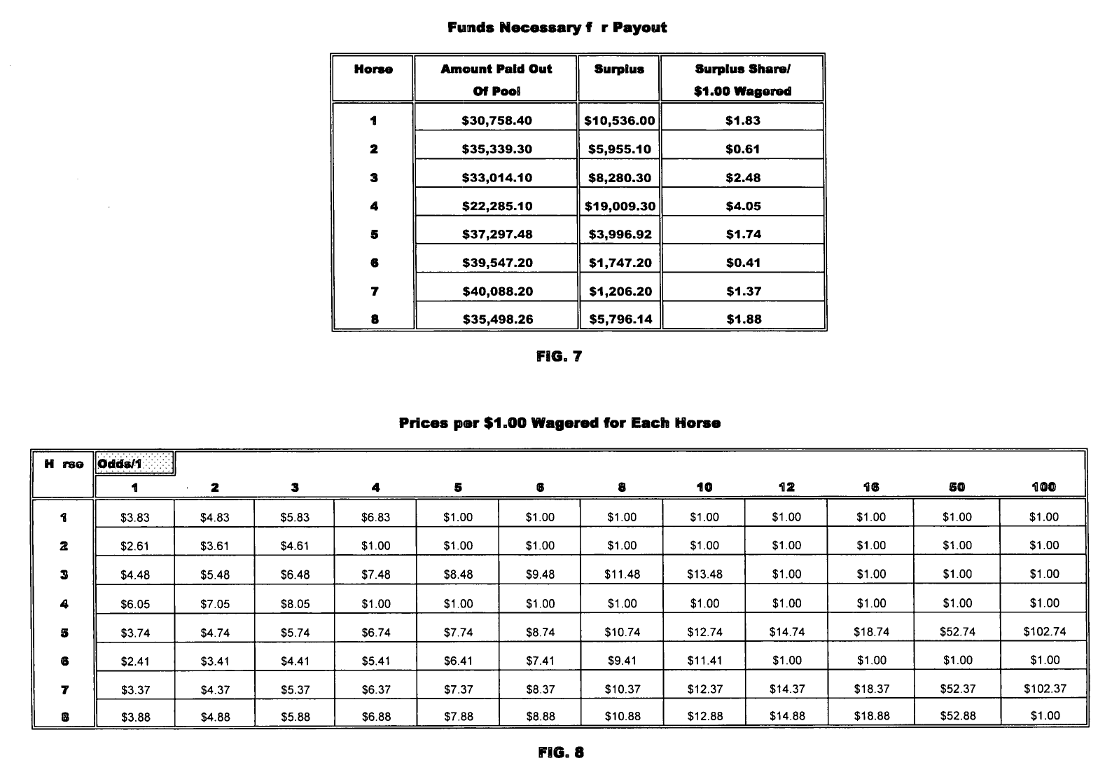

In a first out of money option, original wagers which were placed at odds for which there are insufficient funds in the available pari-mutuel wagering pool to payout all winning game participants, may simply be nullified and returned to the game participants. Those winning game participants that placed wagers for which the funds in the available pari-mutuel wagering pool are sufficient receive a return of their original wager, odds on their original wager, at the odds at which the original wagers were placed, and share in any surplus in the available pari-mutuel wagering pool proportionately to the amount of their original wager. This embodiment is shown in more detail in FIGS. 7 and 8.

FIG. 7 illustrates the amount of surplus that remains in the available pari-mutuel wagering pool once all winning game participants have received a return of their original wager, and those game participants that placed wagers for which the funds in the available pari-mutuel wagering pool were sufficient receive odds on their original wager. For instance, if horse number 1 were to win the race, $30,758.40 would be paid out of the available pari-mutuel wagering pool to payout all winning game participants according to this model and $10,536.00 would remain as surplus. As this scenario pays a proportional share of the surplus to all those who wagered at odds for which the funds in the available pari-mutuel wagering pool were sufficient to pay, the surplus is divided by the total amount of money wagered at or below odds of 4 to 1. Referring to FIG. 4, it can be seen that this amount is $5,767.20 ($1922.40 at 3 to 1 odds and $3,844.80 at 4 to 1 odds). Thus, the surplus share per $1.00 wagered is $1.83 ($10,536.00 divided by $5,767.20).

FIG. 8 illustrates the payout schedule per $1.00 wagered which would be indicated by this model, the payout being broken down according to the various odds for which original wagers were placed. For instance, in the above scenario wherein horse number 1 won the race, all winning game participants that wagered at 1 to 1 odds would receive a return of their original wager, odds on their original wager, at the odds at which the original wager was placed, or $1.00 for each $1.00 wagered, plus a proportional share of the surplus ($1.83 for each $1.00 wagered). Thus, those game participants who wagered at 1 to 1 odds would receive $3.83 for each $1.00 wagered on horse number 1. Similarly, all winning game participants that wagered at 4 to 1 odds would receive a return of their original wager, odds on their original wager, at the odds at which the original wager was placed, or $4.00 for each $1.00 wagered, plus a proportional share of the surplus ($1.83 for each $1.00 wagered). Thus, those winning game participants who wagered at 4 to 1 odds would receive $6.83 for each $1.00 wagered on horse number 1. However, in this scenario, those who wagered at odds for which the available pari-mutuel wagering pool was insufficient to pay (i.e., those winning game participants that wagered at odds above 4 to 1) would receive only a return of their original wager and receive neither odds on their original wager nor a share of the surplus.

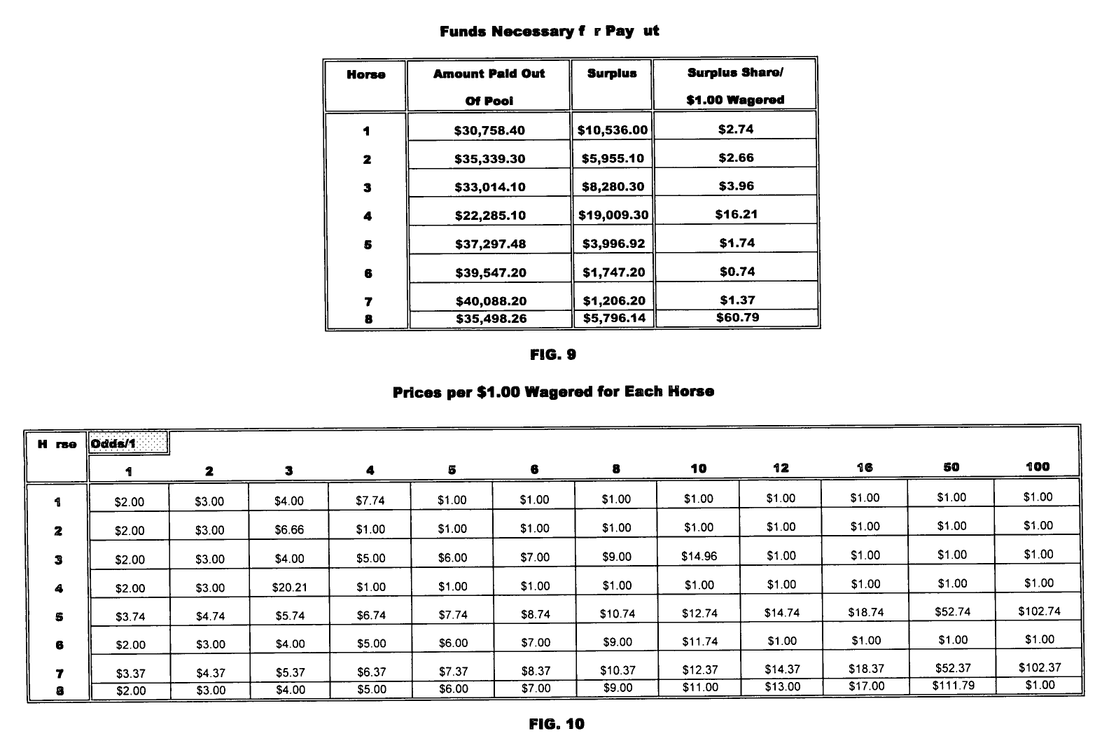

In a second out of money option, the surplus may be shared among only those winning game participants that placed original wagers at the max odds payout, i.e., at the highest odds for which the available pari-mutuel wagering pool contains sufficient funds to payout all winning game participants. Thus, the model rewards those game participants that effectively predict what the max odds payout will be. In this scenario, those winning game participants that placed original wagers on odds below the max odds payout receive a return of their original wager and odds on their original wager, at the odds at which the original wagers were placed. Those winning game participants that placed original wagers on odds above the max odds payout receive only a return of their original wager, the wager in effect being nullified. However, those winning game participants that placed wagers at the max odds payout receive a return of their original wager, odds on their original wager, at the odds level at which the original wagers were placed, and a share of any surplus in the available pari-mutuel wagering pool. Again, the surplus share received by each winning game participant that placed their original wager at the max odds payout would be proportional to the amount of that participant's wager. This embodiment is shown in more detail in FIGS. 9 and 10.

FIG. 9 illustrates the amount of surplus that would remain in the available pari-mutuel wagering pool once all winning game participants receive a return of their original wager, and those game participants that placed wagers for which the finds in the available pari-mutuel wagering pool were sufficient, receive odds on their original wager. Thus, as with the previous scenario, if horse number 1 were to win the race, $10,536.00 would remain as surplus. However, according to this model, a proportional share of the surplus would be paid out only to those winning game participants that wagered at the max odds payout. Accordingly, the surplus would be divided by the total amount of money wagered at the max odds payout, i.e., at 4 to 1 odds in the present example. Referring to FIG. 4, it can be seen that this amount is $3,844.80. Thus, the surplus share per $1.00 wagered would be $2.74 ($10,536.00 divided by $3,844.80).

FIG. 10 illustrates the payout schedule per $1.00 wagered which would be indicated by this model, the payout being broken down according to the various odds for which original wagers were placed. For instance, in the above scenario wherein horse number 1 won the race, all winning game participants that wagered at 1 to 1 odds would receive a return of their original wager, plus odds on their original wager, or $1.00 for each $1.00 wagered. Thus, those winning game participants that wagered at 1 to 1 odds would receive $2.00 for each $1.00 wagered on horse number 1. However, all winning game participants that wagered at 4 to 1 odds (i.e., at the max odds payout) would receive a return of their wager plus odds on their original wager, or $4.00 for each $1.00 wagered, plus a proportional share of the surplus ($2.74 for each $1.00 wagered). Thus, those winning game participants that wagered at 4 to 1 odds would receive $7.74 per $1.00 wagered on horse number 1. In this scenario, those who placed original wagers at odds for which the available pari-mutuel wagering pool was insufficient to pay, would receive only a return of their original wager and would receive neither odds on their original wager nor a share of the surplus.

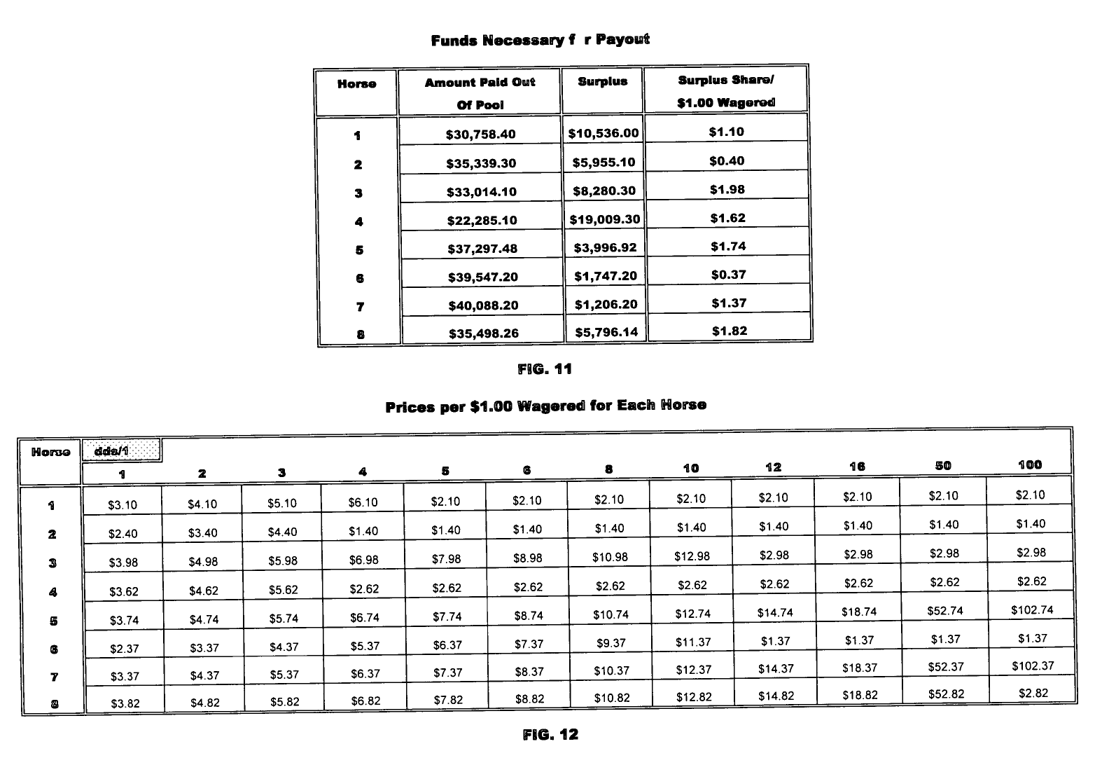

In a third out of money option, any surplus in the available pari-mutuel wagering pool may be shared among all those who wagered on the winning outcome of the event. Thus, the winning game participants that placed original wagers at the max odds payout or below would receive a return of their original wager, odds on their original wager, at the odds level at which their original wager was placed, and a share of any surplus in the available pari-mutuel wagering pool. Those winning game participants who placed original wagers at odds for which the funds in the available pari-mutuel wagering pool are insufficient to payout all winning game participants would receive a return of their original wager and share in any surplus in the available pari-mutuel wagering pool but would not receive odds on their original wager. In this embodiment, the surplus is shared among all those who wagered on the winning outcome of the event in proportion to the amount of each winning game participant's original wager. This embodiment is shown in more detail in FIGS. 11 and 12.

FIG. 11 illustrates the amount of surplus that would remain in the available pari-mutuel wagering pool once all winning game participants receive a return of their original wager, and those winning game participants that placed wagers for which the funds in the available pari-mutuel wagering pool were sufficient to payout, receive odds on their wager. As with the previous models, if horse number 1 were to win the race, $10,536.00 would remain as a surplus. As the present model provides a proportional share of the surplus to all those who wagered on the winning outcome, the surplus would be divided by the total amount of money wagered on horse number 1. Referring to FIG. 4, it can be seen that this amount is $9,612.00. Thus, the surplus share per $1.00 wagered is $1.10 ($10,536.00 divided by $9,612.00).

FIG. 12 illustrates the payout schedule per $1.00 wagered which would be indicated by this model, the payout being broken down according to the various odds for which original wagers were placed. For instance, in the above scenario wherein horse number 1 won the race, all winning game participants that wagered at 1 to 1 odds would receive a return of their original wager, odds on their original wager, or $1.00 for each $1.00 wagered, plus a proportional share of the surplus ($1.10 for each $1.00 wagered). Thus, those winning game participants that wagered at 1 to 1 odds would receive $3.10 for each $1.00 wagered on horse number 1. Similarly, all winning game participants that wagered at the max odds payout of 4 to 1 odds would receive a return of their original wager, odds on their original wager, or $4.00 for each $1.00 wagered, plus a proportional share of the surplus ($1.10 for each $1.00 wagered). Thus, those winning game participants that wagered at 4 to 1 odds would receive $6.10 per $1.00 wagered on horse number 1. According to this model, those winning game participants that wagered at odds for which the available pari-mutuel wagering pool was insufficient to payout all winning game participants would receive a return of their original wager, plus a proportional share of the surplus ($1.10 for each $1.00 wagered). Thus, those winning game participants that wagered at odds above 4 to 1 would receive $2.10 per $1.00 wagered on horse number 1.

It will be understood and appreciated by those of ordinary skill in the art, that the present invention is not limited by the out of money options discussed herein as a variety of ways in which to address the out of money situation may be envisaged. For instance, instead of distributing the surplus to at least a portion of the winning game participants as in each of the above examples, the gaming establishment may retain the surplus and move the funds to a special pool for subsequent jackpots or parlay the funds into a subsequent wager. All such variations are contemplated to be within the scope hereof.

The fixed odds pari-mutuel wagering method of the present invention allows game participants to determine their own proposition (i.e., to specify at what odds or price they will accept a wager). As previously discussed, this is not the case with conventional pari-mutuel wagering. In conventional pari-mutuel wagering, the proposition changes over time based upon the composition of the wagering pool. The final odds paid out may decline based upon wagers placed simultaneously with or subsequent to a game participant placing his or her wager. For instance, with reference to FIG. 4, $45.82 was hypothetically wagered at 50 to 1 odds on horse number 5. If horse number 5 wins the race, an examination of FIGS. 5 and 6 indicates that there would be sufficient funds in the available pari-mutuel wagering pool to payout all winning game participants. Thus, the winning game participants that wagered on horse number 5 at 50 to 1 odds would receive a return of their original wager, $50.00 for each $1.00 wagered on horse number 5, plus a share of any surplus that remained in the available pari-mutuel wagering pool (i.e., $1.74 for each $1.00 wagered on horse number 5). However, if the same horse race were to proceed under a conventional pari-mutuel wagering scheme, wherein all winning game participants receive the same final odds regardless of the odds at which the original wagers are placed, those winning game participants that wagered on horse number 5 at 50 to 1 odds would receive only a return of their original wager plus $18.02 for each $1.00 wagered on horse number 5. Clearly, this is a significant potential loss.

While in fixed odds wagering using an intermediary or bookie, a game participant may “freeze” his odds (i.e., the odds at which his wager may be paid out if placed on a winning outcome will not change from the time the wager is placed until the time at which the appropriate payout is made), he cannot control what propositions will be offered by the bookie. Accordingly, he may not be able to place a wager at his desired price in the first place. Additionally, while in fixed odds individual wagering a game participant can control the propositions offered, he cannot be certain that another game participant will accept that proposition. The fixed odds pari-mutuel wagering method of the present invention permits a game participant to place a wager at his desired proposition without the risk that the odds will decline before he is paid and with the confidence that the wager will either be covered or the original amount of the wager returned to him, potentially with a proportional share of any surplus in the available pari-mutuel wagering pool.

Alternatively, as previously described, known “out of money” wagers may be separated from the wagering pool and refunded to the game participant, or otherwise disposed of, so as to avoid putting a game participant's wager at risk when the composition of the wagering pool is such that his or her wager would not be covered. Additionally, though not currently preferred, a game participant may simply lose an “out of money” wager even though placed on a successful event outcome.

Further, the fixed odds pari-mutuel wagering method of the present invention effectively removes any incentive for game participants to wait until near the end of the period during which wagers on the event will be accepted as the final price will not change between the time the original wager is placed and the time of payout.

In addition, the fixed odds pari-mutuel wagering method of the present invention effectively removes the objection of those game participants that sit out of an event and forego wagering due to unfavorable odds. Odds are unfavorable when the risk of the wager is not sufficiently compensated for by the expected payout. Permitting game participants to specify their own propositions effectively eliminates these types of objections that and increases both handle and customer satisfaction.

The fixed odds pari-mutuel wagering method of the present invention is also favorable to the gaming establishment which hosts or sponsors the event on which wagers are being placed. First, as in conventional pari-mutuel wagering, it eliminates the need for the gaming establishment to “book” wagers, thus taking a position which involves risk to the establishment. The gaming establishment receives a fixed percentage of each dollar wagered, regardless of the outcome of the event. Further, the fixed odds pari-mutuel wagering method of the present invention provides gaming establishments with an alternative to websites which facilitate fixed odds individual wagering but do not typically pay commissions to the gaming establishments.

In another embodiment, the present invention relates to a method of wagering wherein game participants purchase shares in favor of a particular outcome of a given event and, if the particular outcome is a winning outcome, receive a return of the original amount wagered plus a dividend for each share they hold in favor of the winning outcome. In share wagering, shares in favor of each particular outcome may be purchased at current but fluctuating share prices which may be likened to odds in conventional pari-mutuel wagering. That is, $2.00 wagered in favor of a particular outcome at what would be described in conventional pari-mutuel wagering as 12 to 1 odds, will purchase 24 shares in favor of that outcome. As a greater proportion of the funds in the available pari-mutuel wagering pool may be attributed to shares purchased in favor of a particular outcome, the number of shares which may be purchased for the same amount of money will typically decline, just as odds on a particular outcome will decline as increasingly more money is wagered on that outcome in conventional pari-mutuel wagering. Likewise, as a greater proportion of the funds in the available pari-mutuel wagering pool may be attributed to shares purchased in favor of other than the particular outcome, the number of shares which may be purchased for the same amount of money will typically increase. In this way, share prices in favor of any given outcome may fluctuate throughout the share purchasing period. However, once a game participant has purchased shares at a particular share price, he retains those shares until the event is completed. That is, the number of shares held by a game participant does not fluctuate with fluctuating share price.

Once the share purchasing period is closed, the event is commenced and the outcome thereof is determined. Each game participant who placed a wager on a winning outcome of the event subsequently receives a return of their original wager amount and a dividend for each share they hold in favor of the winning outcome. The amount of the dividend is calculated by dividing the funds in the share wagering pool, less the takeout, by the number of outstanding shares purchased in favor of the winning outcome of the event.

Before share wagering may commence, an initial share price for each winning outcome must be set. There are a number of alternatives for setting initial share price, a few of which are discussed by way of example herein. It will be understood and appreciated by those of ordinary skill in the art that each of the alternatives herein discussed may be implemented separately or in combination with one another and that other alternatives may be utilized, alone or in combination, as well. The present invention is not limited by the alternatives for setting initial share price discussed herein.

A first exemplary method for setting initial share price involves a gradual transition from the morning line. As with conventional pari-mutuel wagering, a morning line is established, typically by a knowledgeable employee of the gaming establishment (e.g., the race track) taking into account past performances of the contenders, ratings, speed figures and the like. The morning line is effectively an estimate of what the gaming establishment believes the probable odds will be at post time. Based upon these odds, initial share price may be set. A total value for the wagering pool may also be estimated and a conversion percentage set. For instance, it may be estimated that $100,000 will be wagered on the event and a conversion percentage of 10% may be set. The conversion percentage is largely arbitrarily set and represents the point at which a transition from the morning line to the actual share prices calculated using the funds distribution in the wagering pool will be complete. In this example, once $10,000 has been wagered on the event, the share prices will be actual calculated share prices.

The transition from the morning line commences as soon as shares in favor of various outcomes of the event are purchased. As funds in the wagering pool increase, new share prices may be calculated based upon a blended combination of morning line prices and actual calculated share prices. For instance, when $1,000 has been wagered on the event, the share price in favor of each potential outcome may reflect 10% actual calculated share price based upon the wagering pool composition and 90% morning line share price. As the funds in the wagering pool increase, for instance to $5,000, the share price in favor of each potential outcome may reflect 50% morning line share price and 50% actual calculated share price. Once the funds in the wagering pool reach the predetermined value (i.e., the estimated total value of the wagering pool multiplied by the conversion percentage), $10,000 according to the present example, the pricing of shares may convert to reflect 100% actual calculated share price based upon the wagering pool composition.

It will be understood and appreciated by those of ordinary skill in the art that share prices may be continually updated with each additional dollar added to the wagering pool or may be updated progressively at preset increments, for instance, each time an additional $1,000 is added to the wagering pool. The present invention encompasses any and all such variations in transitioning from morning line share prices to actual calculated share prices.

A second exemplary method for setting initial share price involves setting share prices based upon fixed odds wagering prices. In this method, the initial share price may be calculated based upon the wagering pool composition of a concurrently conducted fixed odds wagering game or a fixed odds wagering game in which the period for accepting wagers has already been closed. It is currently preferred that initial share prices be set based upon a fixed odds wagering game in which the period for accepting wagers has already been closed as this more fully protects the secrecy of the fixed odds wagering game.

Once the share purchasing period has commenced and shares are purchased in favor of the potential outcomes of the event, the composition of the wagering pool may be used to set actual share prices. By way of example and not limitation, this change to actual share prices may be implemented in a transitional form as with the transition from the morning line example, or may be implemented when the funds in the wagering pool reach a preset value.

In a third exemplary method, the initial share price may be set based upon the composition of an existing pari-mutuel pool for the event. For instance, conventional pari-mutuel wagering may be conducted for a pre-set period of time, e.g., twenty minutes, prior to the commencing the share purchasing period. The initial share price may then be based, either completely or partially, on the composition of the conventional pari-mutuel wagering pool. As with the previous exemplary method, once the share purchasing period has commenced and shares are purchased in favor of the potential outcomes of the event, the composition of the share wagering pool may be used to set actual share prices.

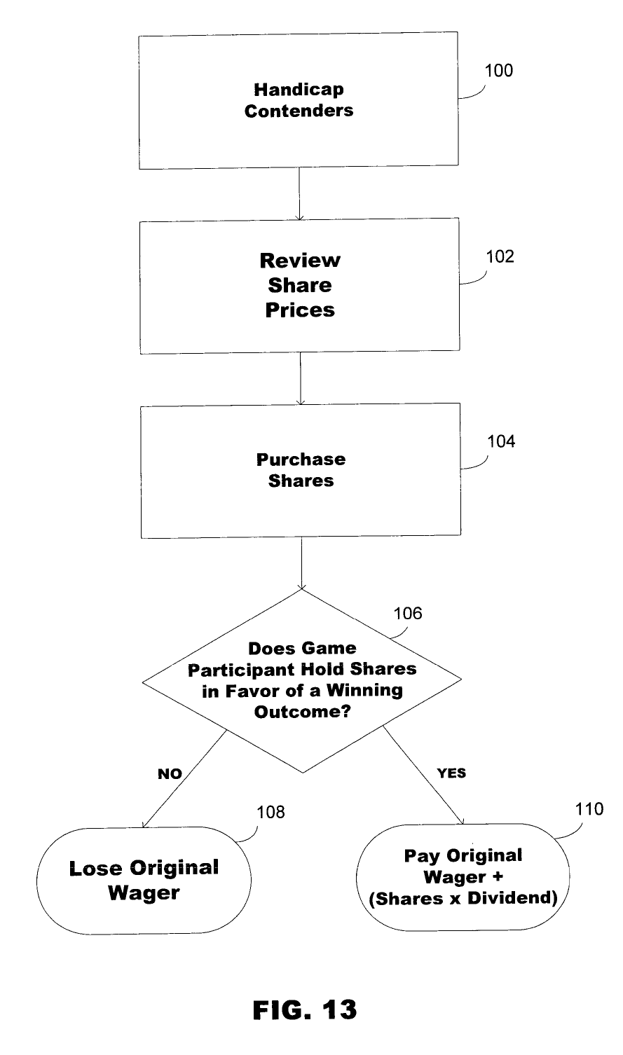

With reference to FIG. 13, a flow diagram showing a method of playing a share purchasing wagering game in accordance with the present invention is schematically illustrated. As shown at reference numeral 100, once initial share prices have been set and the share purchasing period has commenced, each game participant desiring to place one or more wagers on a particular outcome of the event may initially handicap the contenders in the event. For instance, if the event is a horse race, a game participant may examine historical information regarding each horse running the race and form a judgment regarding what he believes the outcome of the race will be. Once a game participant is satisfied with his judgment of the contenders and has decided what he believes a winning outcome of the race will be, he may review the current share prices in favor of that outcome, as shown at reference numeral 102, and, if he determines that the current share price is favorable, he may purchase shares in favor of a particular outcome. This is shown at reference numeral 104.

Share wagering introduces two elements into pari-mutuel wagering that are not present in the conventional form—timing and discriminatory pricing. Due to fluctuations in share price, it may be desirable for a game participant to purchase shares in favor of a particular outcome of an event at various times throughout the share purchasing period. Moreover, it may be desirable to purchase shares in favor of more than one outcome for the same event if the share prices for one or more potential outcomes falls below market value, e.g., if the share price in favor of a particular outcome falls below what historical data suggests is reasonable.

Once the share purchasing period has been closed, the event is commenced and the outcome thereof is determined. This is shown at reference numeral 106 in FIG. 13. If the outcome in favor of which a game participant holds shares is not a winning outcome, the game participant loses his original wager and the shares have no value. This is shown at reference numeral 108. However, if the outcome in favor of which a game participant holds shares is a winning outcome, the game participant receives a return of his original wager plus a dividend for each share held. This is shown at reference numeral 110. The amount of the dividend is calculated by dividing the funds in the share wagering pool, less the takeout, by the number of outstanding shares purchased in favor of the winning outcome of the event.

As previously stated, there is some incentive in conventional pari-mutuel wagering for game participants to wait until near the end of the period in which wagers on the event are being accepted as the odds are less likely to change to any significant degree the closer the wager is placed to the post time. Share wagering lessens this incentive to a significant degree as game participants are effectively able to maintain the odds at which they are willing to accept a wager through the purchase of a set number of shares at those odds, i.e., at the current purchase price, that will not change as the composition of the wagering pool fluctuates.

Share wagering is also favorable to the gaming establishment which hosts or sponsors the event on which wagers are being placed as it eliminates the need for the gaming establishment to “book” wagers, thus taking a position which involves risk to the establishment. The gaming establishment receives a fixed percentage of each dollar wagered, as it does in conventional pari-mutuel wagering, regardless of the outcome of the event.

Many variations of share wagering may be envisioned. For instance, there may be a variety of methods for setting initial share price not specifically delineated herein. Extensions of share wagering may also be envisaged, for instance, schemes for trading shares among game participants may be implemented. The present invention is intended to encompass all such variations and extensions.

Although the foregoing description contains many specifics, these should not be construed as limiting the scope of the present invention, but merely as providing illustrations of some exemplary embodiments. Similarly, other embodiments of the invention may be devised which do not depart from the spirit or scope of the present invention. Features from different embodiments may be employed in combination. The scope of the invention is, therefore, indicated and limited only by the appended claims and their legal equivalents, rather than by the foregoing description. All additions, deletion and modifications to the invention, as disclosed herein, which fall within the meaning and scope of the claims are to be embraced thereby.

1. A method of playing a pari-mutuel wagering game, comprising:
identifying a plurality of potential outcomes for an event;
affording a plurality of game participants an opportunity to place a wager on one or more of the plurality of potential outcomes and to specify an odds level of a plurality of progressive odds levels at which the wager is accepted;
forming a pari-mutuel wagering pool having funds comprised of all wagers placed;
recording an amount of each game participant's wager and the specified odds level accepted for each wager;
identifying at least one of the plurality of potential outcomes as a winning outcome for the event;
identifying all game participants of the plurality of game participants that placed a wager on the winning outcome as winning game participants; and
distributing, from the pari-mutuel wagering pool, an appropriate payout to each winning game participant.

2. The method of claim 1, wherein distributing an appropriate payout to each winning game participant comprises returning to each winning game participant the amount of that game participant's wager.

3. The method of claim 1, further comprising determining whether the funds in the pari-mutuel wagering pool are sufficient to return to each winning game participant the amount of that game participant's wager and to pay odds on each winning game participant's wager at the specified odds level accepted for each wager.

4. The method of claim 3, wherein if it is determined that the funds in the pari-mutuel wagering pool are sufficient, distributing an appropriate payout to each winning game participant comprises returning to each winning game participant the amount of that game participant's wager and paying odds on each winning game participant's wager at the specified odds level accepted for that wager.

5. The method of claim 3, wherein if it is determined that the funds in the pari-mutuel wagering pool are not sufficient, the method further comprises determining the cumulative amounts necessary to pay odds on each wager placed by a winning game participant at each odds level of the plurality of progressive odds levels and to pay odds on each wager placed by a winning game participant at an odds levels below each odds level of the plurality of progressive odds levels.

6. The method of claim 5, further comprising determining a max odds payout at a particular odds level at which the funds in the pari-mutuel wagering pool are sufficient to pay odds on all wagers placed by the winning game participants at the particular odds level and to pay odds on all wagers placed by the winning game participants at odds levels of the plurality of progressive odds levels that are below the particular odds level.

7. The method of claim 6, wherein distributing an appropriate payout to each winning game participant comprises returning to each winning game participant the amount of that game participant's wager and paying odds on each wager placed by a winning game participant at the max odds payout or at an odds level of the plurality of progressive odds levels that is below the max odds payout.

8. The method of claim 4, further comprising determining whether there is surplus of the funds in the pari-mutuel wagering pool subsequent to returning to each winning game participant the amount of that game participant's wager and paying odds on each winning game participant's wager at the specified odds level accepted for that wager.

9. The method of claim 8, wherein if there is a surplus of the funds in the pari-mutuel wagering pool, distributing an appropriate payout to each winning game participant further comprises distributing a share of the surplus of the funds to all the winning game participants, which share is proportional to each winning game participant's wager.

10. The method of claim 7, further comprising determining whether there is surplus of the funds in the pari-mutuel wagering pool subsequent to returning to each winning game participant the amount of that game participant's wager and paying odds on each wager placed by a winning game participant at the max odds payout or at an odds level below the max odds payout.

11. The method of claim 10, wherein if there is a surplus of the funds in the pari-mutuel wagering pool, distributing an appropriate payout to each winning game participant further comprises distributing a share of the surplus of the funds to at least a subset of the winning game participants, which share is proportional to each winning game participant's wager.

12. The method of claim 11, wherein distributing a share of the surplus of the funds to at least a subset of the winning game participants comprises distributing a share of the surplus to all the winning game participants.

13. The method of claim 11, wherein distributing a share of the surplus of the funds to at least a subset of the winning game participants comprises distributing a share of the surplus to all the winning game participants that placed a wager at the max odds payout.

14. The method of claim 11, wherein distributing a share of the surplus of funds to at least a subset of the winning game participants comprises distributing a share of the surplus to all winning game participants that placed a wager at the max odds payout or at an odds level of the plurality of progressive odds levels that is below the max odds payout.

15. The method of claim 4, further comprising subtracting a takeout share from the pari-mutuel wagering pool prior to distributing an appropriate payout to each winning game participant.

16. The method of claim 7, further comprising subtracting a takeout share from the pari-mutuel wagering pool prior to distributing an appropriate payout to each winning game participant.

17. A method of playing a pari-mutuel wagering game, comprising:
placing a wager on at least one outcome of a plurality of potential outcomes for an event, the wager being placed in a pari-mutuel wagering pool;
specifying, at the time the wager is placed, odds at which the wager is accepted; and
if the at least one outcome is a winning outcome, receiving an appropriate payout.

18. The method of claim 17, wherein receiving an appropriate payout comprises:
receiving a return of the wager; and
if the pari-mutuel wagering pool contains sufficient funds, receiving odds on the wager at the odds at which the wager was accepted.

19. The method of claim 18, wherein receiving an appropriate payout further comprises receiving a share of a surplus of funds from the pari-mutuel wagering pool, which share is proportional to the wager.

20. A method of playing a pari-mutuel wagering game, comprising:
identifying a plurality of potential outcomes for an event;
setting an initial share price for each of the plurality of potential outcomes;
affording a plurality of game participants an opportunity to purchase at least one share in favor of at least one outcome of the plurality of potential outcomes at the initial share price;
determining an adjusted share price for each of the plurality of potential outcomes;
affording the plurality of game participants an opportunity to purchase at least one share in favor of the at least one outcome of the plurality of potential outcomes at the adjusted share price;
forming a pari-mutuel wagering pool comprising funds received for each share purchased;
identifying at least one winning outcome from the plurality of potential outcomes for the event; and
distributing, from the pari-mutuel wagering pool, an appropriate payout to each game participant that purchased at least one share in favor of the winning outcome.

21. The method of claim 20, wherein distributing an appropriate payout to each game participant that purchased at least one share in favor of the at least one winning outcome comprises distributing to each game participant that purchased at least one share in favor of the at least one winning outcome funds equivalent to the share price at which each share in favor of the at least one winning outcome was purchased.

22. The method of claim 20, further comprising:
determining a total number of shares purchased in favor of the at least one winning outcome; and
determining a total value of the funds comprising the pari-mutuel wagering pool.

23. The method of claim 22, further comprising determining a dividend value for each share purchased in favor of the at least one winning outcome by dividing the total value of the funds comprising the pari-mutuel wagering pool by the total number of shares purchased in favor of the at least one winning outcome.

24. The method of claim 23, wherein distributing an appropriate payout to each game participant that purchased at least one share in favor of the winning outcome comprises distributing to each game participant that purchased at least one share in favor of the winning outcome, funds equivalent to the share price at which each share in favor of the winning outcome was purchased and the dividend value for each such share purchased in favor of the winning outcome.

25. A method of playing a pari-mutuel wagering game, comprising:
purchasing at least one share in favor of a particular outcome of a plurality of potential outcomes for an event at a share price, funds for each share purchased being placed in a pari-mutuel wagering pool; and
if the particular outcome in favor of which the at least one share was purchased is a winning outcome, receiving an appropriate payout.

26. The method of claim 25, wherein receiving an appropriate payout comprises:
receiving funds equivalent to the share price at which each share in favor of the winning outcome was purchased; and
receiving a dividend for each share purchased in favor of the winning outcome.
